(19) United States
(12) Patent Application Publication
(10) Pub. No.: US 2024/0333534 A1
(43) Pub. Date: Oct. 3, 2024

(54) SYSTEMS AND METHODS FOR IDENTITY AUTHENTICATION USING MULTIPLE-CHOICE SHARED SECRET QUESTIONS

(71) Applicant: LexisNexis Risk Solutions Inc., Alpharetta, GA (US)

(72) Inventors: Yaniv Koss, Tel-Aviv (IL); David Buchler, Boca Raton, FL (US)

(21) Appl. No.: 18/194,735

(22) Filed: Apr. 3, 2023

(51) Int. Cl. H04L 9/32

(52) U.S. Cl. CPC H04L 9/3271

(57) ABSTRACT

Systems and methods are provided for authenticating users for access to a service using shared secret questions. A method can include displaying an authentication question and a plurality of choices for the user to select. The plurality of choices includes one or more of: a previously selected user-preferred answer corresponding to a user-selected authentication question and one or more predefined choices corresponding to a previous selection of an authentication question. The method includes receiving a user selection indication from the plurality of multiple choices, verifying that the user selection indication from the plurality of choices matches a previously stored user selection of the user-preferred answer to the selected authentication question; and responsive to the verification, authenticating the user for access to the service.

### FIELD

The disclosed technology generally relates to secure communication systems and, more particularly, to shared secret authentication techniques used to verify the identity of a user.

### BACKGROUND

In today's interconnected world, communication and data exchange between individuals, organizations, and devices have become increasingly essential. However, with the growing dependence on electronic communication and data storage, the risk of unauthorized access, data theft, and cyber-attacks has also increased. It is therefore necessary to implement robust security measures to protect sensitive data from unauthorized access.

One common method of ensuring secure communication and data exchange is authentication by verifying the identity of a user or entity before granting access to a resource or system. There are many techniques used for authentication, including passwords, biometrics, tokens, and certificates. However, each of these methods has its limitations and vulnerabilities.

Shared secret authentication is a well-known technique that involves the use of a secret that is shared between two parties, typically a user and a system or service provider. The shared secret can be utilized to authenticate the identity of a user when the user attempts to access the system or service. One widely used implementation of shared secret authentication is the use of a phrase. In this case, the phrase is the shared secret, and the user must provide the correct phrase to prove their identity.

Shared secret authentication has many advantages over other authentication methods. It is simple to implement, does not require specialized hardware, and can be used in many different types of systems and applications. However, conventional shared secret authentication solutions (as illustrated in FIG. 1) have two significant drawbacks: (1) users may forget the specific format in which they provided their answers, such as spelling or abbreviations, which can make it difficult for them to provide the same answer in the future; and (2) many users do not provide genuine answers, instead opting for irrelevant or even profane responses that do not pertain to the prompt that asks the user to recall their previously provided secret, which can render the conventional shared secret process useless for authentication.

Therefore, there is a need for an improved shared secret authentication technique that can address shortcomings of the conventional solutions while maintaining the simplicity and versatility of traditional shared secret authentication.

### BRIEF SUMMARY

Some or all of the above needs may be addressed by certain implementations of the disclosed technology. Systems and methods are disclosed herein for implementing an authentication process that utilizes user-selected shared secrets from a predefined list of choices, eliminating issues that are associated with conventional freeform text entry of shared secrets.

In an example implementation, a computer-implemented method is provided to authenticate a user for access to a service using shared secret questions. In certain exemplary implementations, the method may include an enrollment phase and an authentication phase.

During the enrollment phase, the method can include displaying, via a user interface, a first plurality of predefined authentication questions, each of the predefined authentication questions having a second plurality of corresponding predefined answers; receiving, in response to the displaying, a user selection indication of a selected authentication question from the first plurality of predefined authentication questions; displaying, in response to the user selection indication of the selected authentication question, at least a subset of the second plurality of corresponding predefined answers; receiving a user selection indication of a user-preferred answer from the second plurality of corresponding predefined answers; and storing the user selection indication of the selected authentication question and the user selection of the user-preferred answer to the selected authentication question.

During the authentication phase, the method can include displaying the selected authentication question and a third plurality of choices for the user to select, the third plurality of choices comprising one or more of: the user-preferred answer corresponding to the selected authentication question; and one or more predefined choices corresponding to the user selection indication of the selected authentication question. The method can include receiving a user selection indication from the third plurality of choices; verifying that the user selection indication from the third plurality of choices matches the stored user selection of the user-preferred answer to the selected authentication question; and responsive to the verification, authenticating the user for access to the service.

Another computer-implemented method is provided to authenticate a user for access to a service using shared secret questions. The method can include displaying a user-selected authentication question and a plurality of choices for the user to select, the plurality of choices comprising one or more of: a previously selected user-preferred answer corresponding to the user-selected authentication question; and one or more predefined choices corresponding to a user selection indication of the user-selected authentication question; receiving a user selection indication from the plurality of choices; verifying that the user selection indication from the plurality of choices matches a previously stored user selection of the user-preferred answer to the selected authentication question; and responsive to the verification, authenticating the user for access to the service.

According to another example implementation, a system is provided user authentication using shared secret questions. The system includes a data repository configured for storing predefined authentication questions, predefined choices, user-selected predefined authentication questions, and user-selected answer choices; a user interface configured for displaying the predefined authentication questions and receiving user selection indication of a preferred answer from a list of the predefined choices; a comparison module for verifying that a user-selected preferred answer choice matches a previously selected preferred answer from the predefined choices; and at least one memory for storing data and computer-executable instructions; and at least one processor configured to access the at least one memory and further configured to execute the computer-executable instructions that cause the at least one processor to display, via the user interface, a user previously selected authentication question and a plurality of corresponding choices for the user to select, the plurality of corresponding choices comprising one or more of a previously selected user-preferred answer corresponding to the user previously selected authentication question; and one or more predefined choices corresponding to the user previously selected authentication question; receive, via the user interface, a user selection indication of a selected answer from the plurality of choices; compare, via the comparison module, the user selection indication with a previously selected preferred answer from the predefined choices; verify that the user selection indication matches the previously selected preferred answer from the predefined choices; and responsive to the verification, authenticate the user for access to a service.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 illustrates a conventional shared secret process that utilizes freeform entry of text, requiring the user to enter answers during authentication with the same formatting and spelling as the user submitted during enrollment.

FIG. 2 is a block diagram of a shared secret authentication system, according to an example implementation of the disclosed technology.

FIG. 3 is another block diagram of an authentication system, according to an example implementation of the disclosed technology.

FIG. 4 depicts an example enrollment user interface including selection panes for user-selection of authentication question topics and a multiple-choice set of predefined answers to a selected authentication question for user selection, according to an example implementation of the disclosed technology.

FIG. 5 depicts an example authentication user interface including a selection pane for user-selection of predefined answers to a previously selected authentication question, according to an example implementation of the disclosed technology.

FIG. 6 is a block diagram depiction of a computing device, in accordance with certain exemplary implementations of the disclosed technology.

FIG. 7 is a flow diagram of a method, according to an example implementation of the disclosed technology.

FIG. 8 is a flow diagram of another method, according to an example implementation of the disclosed technology.

### DETAILED DESCRIPTION

The disclosed technology provides a novel shared secret authentication technique that enhances security and provides a more reliable and user-friendly authentication mechanism. Exemplary implementations of the disclosed technology can provide certain improvements over conventional shared-secret methods, which are commonly used to authenticate users and protect against fraud.

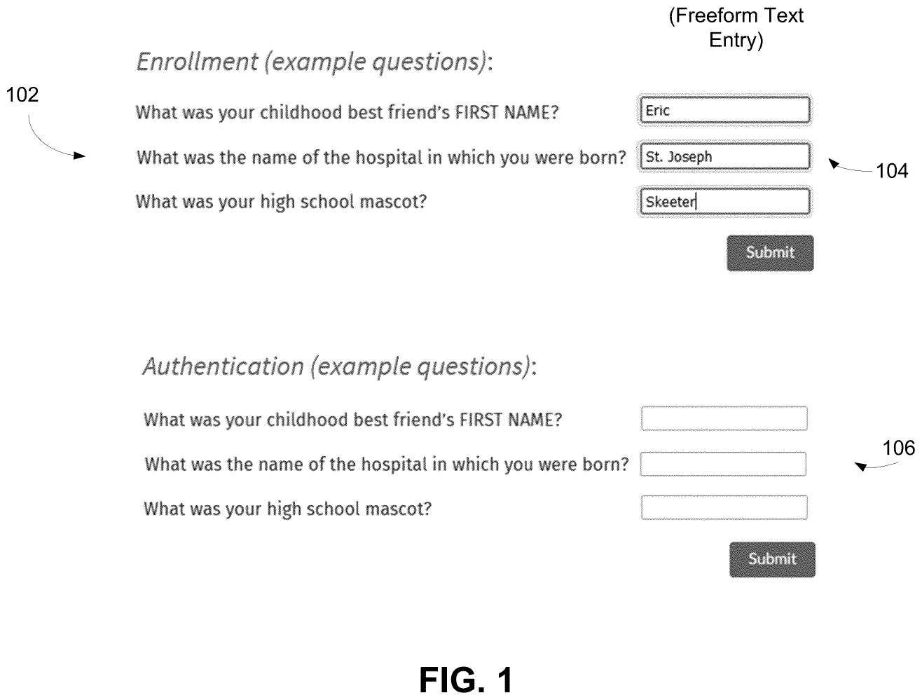

FIG. 1 illustrates a conventional shared secret process that utilizes freeform entry of text. In an enrollment phase of the conventional shared secret process, the user may be presented with (or may select) a series of security questions 102, and the user may enter freeform custom answers 104 to the security questions. Then, during the authentication phase, the user may be presented with one or more of the previous security questions, and the user may be required to enter the same text (with spelling, punctuation, content, etc.) as was entered when the user previously answered the question(s) during enrollment. Such existing implementations of this conventional process can have significant drawbacks. For example, the user may forget the specific format in which they provided their answers, such as spelling or abbreviations, which can make it difficult for them to provide the same answer in the future. Additionally, it is known that many users do not provide genuine answers, instead opting for irrelevant or even profane responses that are non-ideal for authentication purposes.

Certain implementations of the disclosed technology may be utilized to address the above-referenced drawbacks of the conventional solutions by providing an innovative approach that presents security questions as multiple-choice questions with predefined answer options. By limiting users to choosing their answers from a set of predefined options during enrollment, users only need to remember which predefined answer they selected during enrollment, rather than the exact phrasing or format of their response, which makes it easier for them to provide the correct answer in the future. The disclosed technology can further eliminate the potential for users to provide irrelevant or profane responses.

Certain exemplary implementations of the disclosed technology can enable the inclusion of false choices that have the same structure and format as the correct answer, making it more difficult for fraudsters to guess the correct answer. Furthermore, certain implementations may use standard formatting so that answers may be selected from a pre-defined list without calling attention to different formatting, etc. The disclosed technology can provide a more secure and user-friendly authentication solution and may enable companies to protect against fraud, enhance, the user experience, and/or eliminate some of the common authentication issues that can arise with conventional shared secret authentication solutions that utilize freeform text entry.

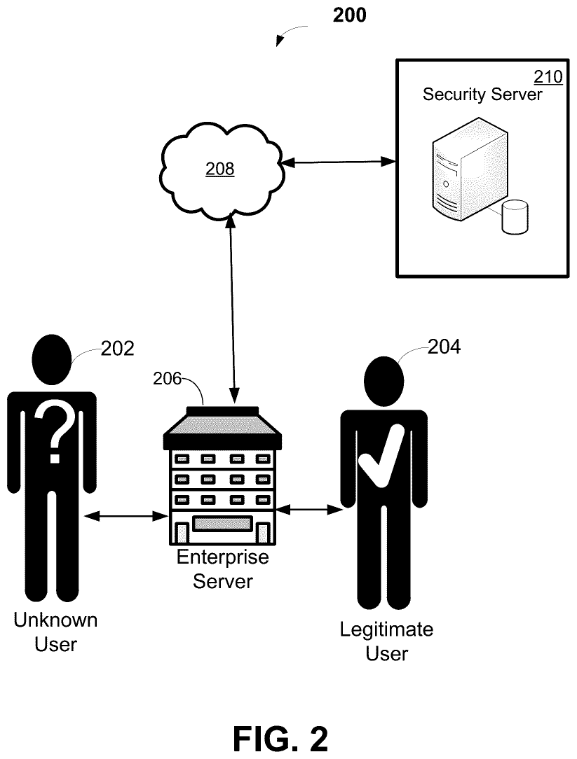

FIG. 2 is a high-level block diagram of a shared secret authentication system 200, according to an example implementation of the disclosed technology. The system 200 may be configured to distinguish between an unknown user 202 and a legitimate user 204 who requests access to an online service of the enterprise server 206. The enterprise server 206, for example, may be associated with an enterprise such as a business, governmental agency, online retailer, etc. The system 200 may further include (or be in communication via a network 208 with) a security server 210 that may work in tandem with the enterprise server 206, for example, to provide pre-defined security questions and corresponding choices that may be selected to verify and authenticate a legitimate user 204 for access to the online service of the enterprise server 206, as will be further discussed below.

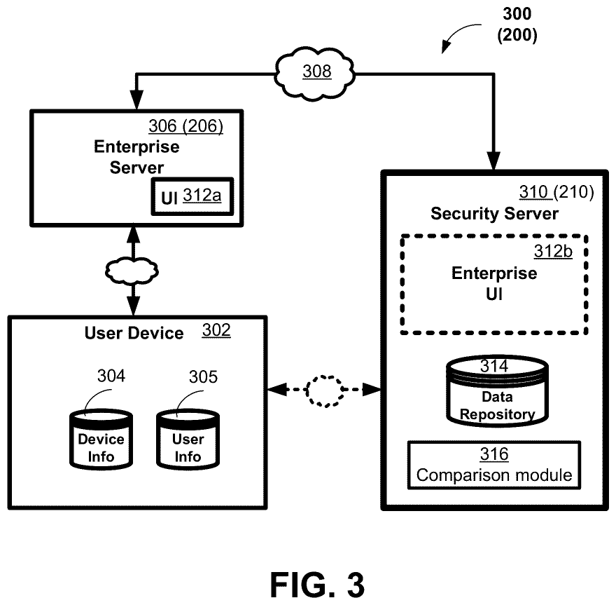

FIG. 3 is a block diagram of a shared secret authentication system 300, according to an example implementation of the disclosed technology, which may correspond to the high-level authentication system 200 discussed above with reference to FIG. 2. In accordance with certain exemplary implementations of the disclosed technology, a user (legitimate or otherwise) may utilize a user device 302 (such as a computer, tablet, mobile phone, smartphone, etc.) to communicate with an enterprise server 306 for enrollment and/or authentication for access to an online service. In certain exemplary implementations, certain device information 304 and/or user information 305 stored on the user device 302 may be utilized in conjunction with the disclosed technology as an additional layer of security, for example, to confirm the use of a recognized device for authentication by an associated user. Examples of device information 304 include a unique device identifier (UDID), an identifier for advertisers (IDFA), an internet protocol (IP) address, a MAC address, and the like.

In certain exemplary implementations, the enterprise server 306 may be in communication with a security server 310 via a network 308 such as the Internet, wide area network, local area network, etc. The security server 310 may include a data repository 314 for storing and/or retrieving authentication questions, answers, user selection indications, etc. In certain exemplary implementations, the security server 310 may include a comparison module 316 that may be utilized to compare user answer selections during an authentication phase with previous answers selected during an enrollment phase.

In accordance with certain exemplary implementations of the disclosed technology, the enterprise server 306 may provide a user interface (UI) 312a for communication with the user device 302. In certain exemplary implementations, the control, formatting, presentation, display, capture of user responses, etc., may be coordinated by the enterprise server 306 via the UI 312a, in communication with the security server 310. In an optional example implementation, the security server 310 may “host” an enterprise UI 312b, for example, so that user enrollment and/or authentication may be processed by the security server 310. In certain exemplary implementations, the user device 312 may connect (via the network 308) with security server 310. In certain exemplary implementations, enterprise server 306 may redirect the user device 302 to the security server 310 to perform enrollment and/or authentication.

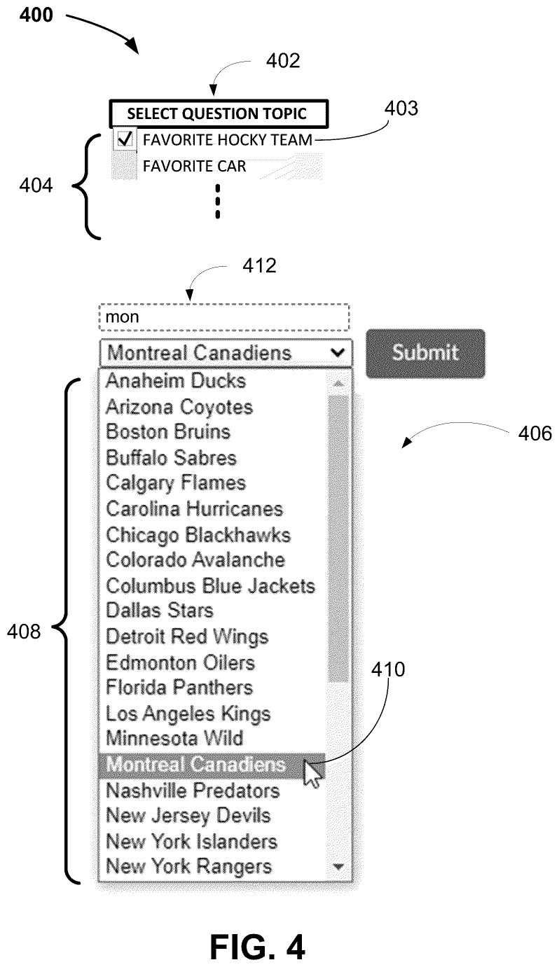

FIG. 4 depicts an example enrollment user interface 400 including an authentication question topic pane 402 and an answer pane 406 that may be utilized by the user, for example, to select one preferred answer 410 from a multiple-choice set of predefined answers 408 to a selected 403 authentication question 404. In certain exemplary implementations, the answer pane 406 may include an autocomplete box 412, where the user can start typing, and corresponding autocomplete suggestions (which can include a partial list) can be presented for further selection. In this respect, the user may select one of the predefined choices from either the full list of choices, or the partial list based on the autocomplete. During the enrollment phase, a first plurality of predefined authentication questions 404 may be displayed to the user for selection. Each of the predefined authentication questions 404 may have an associated second plurality of corresponding predefined answers 408. The user may provide an indication of a selected authentication question 403 from the first plurality of predefined authentication questions 404. In response to the user selection indication of the selected authentication question 403, the second plurality of corresponding predefined answers 408 may be displayed in the answer pane 406. The user may provide their selection indication of a user-preferred answer 410 from the second plurality of corresponding predefined answers 408. In accordance with certain exemplary implementations of the disclosed technology, the user selection indication of the selected authentication question 403 and the user selection of the user-preferred answer 410 to the selected authentication question may be stored for later authentication of the user.

The disclosed technology may be distinguished from previous enrollment and/or authentication systems and methods by the use of the predefined multiple-choice questions 404, each with a set of predefined answers 408 for each question 404. In certain exemplary implementations, the user may select their preferred answer 410 from the predefined list 408 during enrollment. Requiring that users pick their answer from the predefined list 408 can prevent the users from providing freeform answers that would stand out from the other answers, and the user only has to remember which answer they selected during enrollment without having to remember the formatting of the text. Additionally, the predefined list 408 allows displaying false choices to present together with the previous user-selected correct answer 410 to the selected multiple-choice question 403 during authentication (as will be discussed below), such that the selectable answers have uniform structure and formatting so that none stand out compared to the other answers. Certain implementations may utilize one or more “Red-Herring” questions in which the correct answer is “none of the above.” Accordingly, certain implementations may intentionally avoid displaying the user-preferred answer during authentication, but rather, may display only false choices, for which “none of the above” would be the correct answer to the Red-Herring question.

The term “multiple choice question” as used herein, can refer to a question having a complete list of predefined choices for selection during the enrollment phase, and a partial list of predefined choices for selection during the authentication phase.

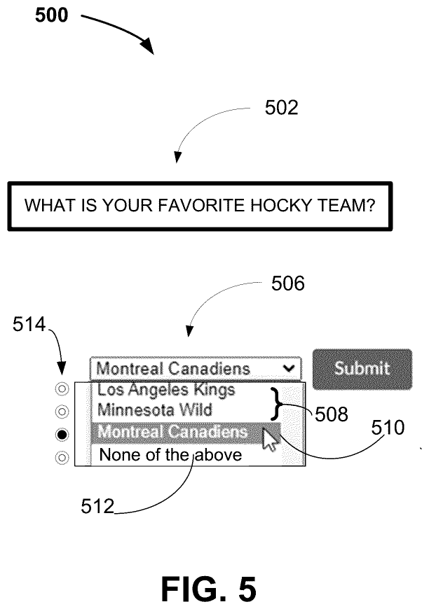

FIG. 5 depicts an example authentication user interface 500 including a selection pane 506 for user-selection of predefined answers to a previously selected authentication question, according to an example implementation of the disclosed technology. During the authentication phase, an authentication question 502 may be displayed. In certain exemplary implementations, this authentication question 502 may correspond to a previously selected question (such as the authentication question 403 selected during enrollment as discussed above with respect to FIG. 4). A third plurality of choices may be presented in a selection pane 506 for the user to select. In certain exemplary implementations, choices may be displayed with radio buttons 514 next to them, allowing the user to click the radio button 514 to choose one of the choices. In certain exemplary implementations, the third plurality of choices can include one or more of the user-preferred answer 510 corresponding to the previously selected authentication question, one or more predefined choices 508 corresponding to the user selection indication of the selected authentication question, and/or a “none of the above” answer 512. In certain implementations, the selection pane 506 may be programmed to randomly be populated with one or more predefined choices 508 that do not correspond to the user preferred answer 510, in which case, the user selection of “none of the above” 512 may be considered the correct answer.

In accordance with certain exemplary implementations of the disclosed technology, the user selection indication to select one answer from the third plurality of choices (508, 510, 512) may be utilized to verify a match with the stored user selection of the user-preferred answer to the selected authentication question (for example, as selected during enrollment). Responsive to a match verification, the user may be authenticated for access to the service.

In accordance with certain exemplary implementations of the disclosed technology, an automatic selection of which of the previously enrolled shared secrets to use may be defined by a combination of configurable parameters, as well as some randomness. For each question, certain implementation may use the “shared secret” (the correct answer) and add several random choices taken from the predefined list of possible answers to be the wrong choices. For example, with the question “Which NFL team is your favorite?”, during enrollment, the predefined list of choices can include the full list of all 32 NFL team names. In the user selects the Miami Dolphins as their favorite NFL team during enrollment, when the authentication question is generated, the disclosed technology may, display the answer “Miami Dolphins” with a few other random choices as a multiple choice question:

Which NFL team is your favorite?
1. Dallas Cowboys
2. New York Jets
3. Miami Dolphins
4. Green Bay Packers
5. None of the above

In certain exemplary implementations, some portion of the questions presented during the authentication will deliberately not include the correct answer on occasion, so that the correct choice is “None of the above” (also known as a “Red-Herring” question) which can be a strong method of deflecting fraud without exposing the user's true secret answer as one of the choices.

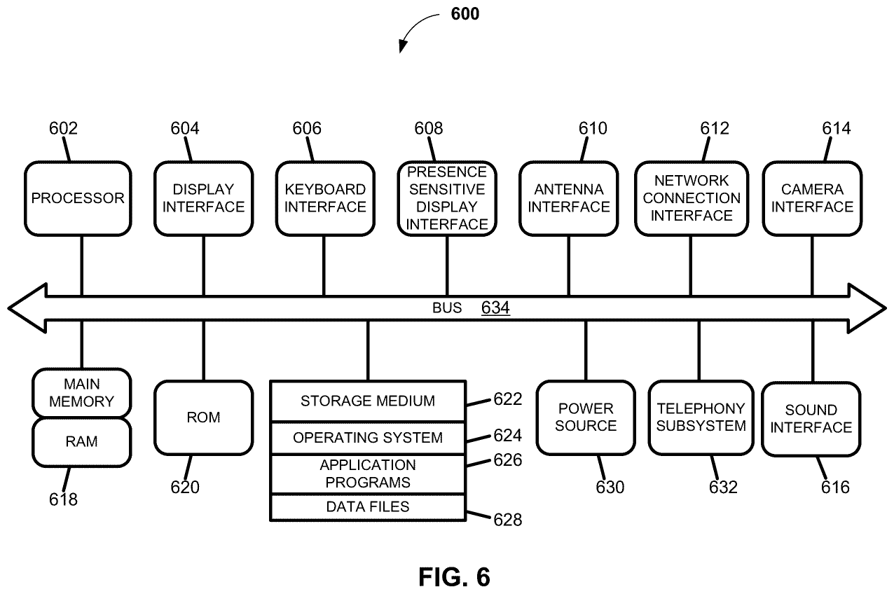

FIG. 6 is a block diagram of an illustrative computing device 600 that may be utilized for the identity enrollment and authentication process, according to an example implementation of the disclosed technology. The computing device 600 may handle various aspects of the process, including communicating with the various entities and/or external systems involved in the authentication process. For example, the computing device 600 may communicate via one or more cloud, Internet, or other network channels to send and/or receive information and retrieve target and control images. For example, the computing device 600 may receive identity information related to the user, and independent information may be received in response to querying one or more public or private databases.

The computing device 600 of FIG. 6 includes a central processing unit (CPU) 602, where computer instructions are processed; a display interface 604 that acts as a communication interface and provides functions for rendering video, graphics, images, and texts on the display. In certain example implementations of the disclosed technology, the display interface 604 may be directly connected to a local display, such as a touch-screen display associated with a mobile computing device. In another example implementation, the display interface 604 may be configured for providing data, images, and other information for an external/remote display that is not necessarily physically connected to the computing device. For example, a desktop monitor may be utilized for mirroring graphics and other information that is presented on the computing device 600. In certain example implementations, the display interface 604 may wirelessly communicate, for example, via a Wi-Fi channel or other network connection interface 612 to an external/remote display.

In an example implementation, the network connection interface 412 may be configured as a communication interface, for example, to provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof.

The computing device 600 may include a keyboard interface 606 that provides a communication interface to a keyboard. In one example implementation, the computing device 600 may include a presence sensor interface 608 for interfacing with a pointing device and/or touch screen. According to certain example implementations of the disclosed technology, the presence sensor interface 608 may provide a communication interface to various devices such as a pointing device, a touch screen, a depth camera, etc. which may or may not be associated with a display.

The computing device 600 may be configured to use an input device via one or more of the input/output interfaces (for example, the keyboard interface 606, the display interface 604, the presence sensor interface 608, the network connection interface 612, the camera interface 614, sound interface 616, etc. . . . ) to allow a user to capture information into the computing device 600. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor such as an accelerometer or gyroscope, a smartcard, iris reader, fingerprint reader, voiceprint reader, and the like. Additionally, the input device may be integrated with the computing device 600 or may be a separate device.

Example implementations of the computing device 600 may include an antenna interface 610 that provides a communication interface to an antenna; a network connection interface 612 that provides a communication interface to a network. In certain implementations, a camera interface 614 is provided for capturing digital images, for example, from a camera. In certain implementations, a sound interface 616 is provided as a communication interface for converting sound into electrical signals using a microphone and for converting electrical signals into sound using a speaker. According to example implementations, a random-access memory (RAM) 618 is provided, where computer instructions and data may be stored in a volatile memory device for processing by the CPU 602.

According to an example implementation, the computing device 600 includes a read-only memory (ROM) 620 where invariant low-level system code or data for basic system functions such as basic input and output (I/O), startup, or reception of keystrokes from a keyboard are stored in a non-volatile memory device. According to an example implementation, the computing device 600 includes a storage medium 622 or another suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, a web browser application, an invoice extraction module, etc.) and data files 628 are stored. According to an example implementation, the computing device 600 includes a power source 630 that provides an appropriate alternating current (AC) or direct current (DC) to power components. According to an example implementation, the computing device 600 may include a telephony subsystem 632 that allows the device 600 to transmit and receive sound over a telephone network. The constituent devices and the CPU 602 communicate with each other over a bus 634.

In accordance with an example implementation, the CPU 602 has an appropriate structure to be a computer processor. In one arrangement, the computer CPU 602 may include more than one processing unit. The RAM 618 interfaces with the computer bus 634 to provide quick RAM storage to the CPU 602 during the execution of software programs such as the operating system application programs, and device drivers. More specifically, the CPU 602 loads computer-executable process steps from the storage medium 622 or other media into a field of the RAM 618 in order to execute software programs. Data may be stored in RAM 618, where the data may be accessed by the computer CPU 602 during execution. In one example configuration, the device 600 includes at least 128 MB of RAM, and 256 MB of flash memory.

The storage medium 622 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 600 to access computer-executable process steps, application programs, and the like that are stored on removable and non-removable memory media, to off-load data from the device 600 or to upload data onto the device 600. A computer program product, such as one utilizing a communication system may be tangibly embodied in storage medium 622, which may comprise a machine-readable storage medium.

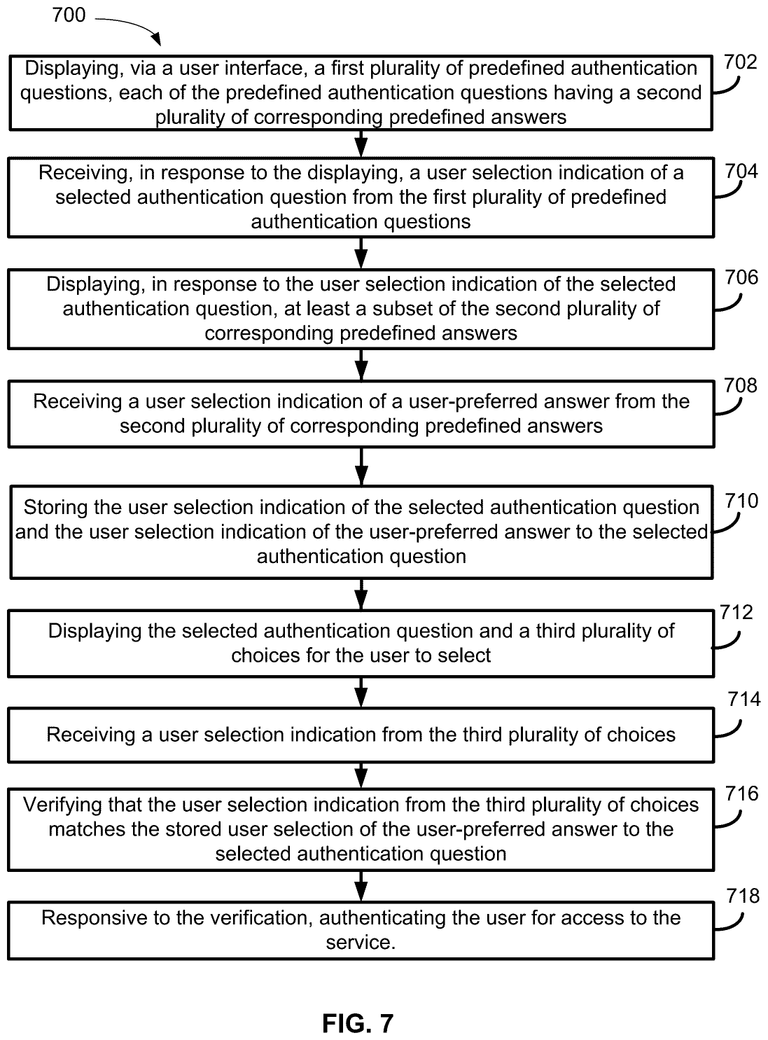

FIG. 7 is a flow diagram of a method 700 for user enrollment and authentication for access to a service using shared secret questions, according to an example implementation of the disclosed technology, which can cover an enrollment process for a user and an associated authentication process for the user. During the enrollment phase, the method 700 begins in block 702 and includes displaying, via a user interface, a first plurality of predefined authentication questions, each of the predefined authentication questions having a second plurality of corresponding predefined answers. In block 704, the method 700 includes receiving, in response to the displaying, a user selection indication of a selected authentication question from the first plurality of predefined authentication questions. In block 706, the method 700 includes displaying, in response to the user selection indication of the selected authentication question, at least a subset of the second plurality of corresponding predefined answers. In block 708, the method 700 includes receiving a user selection indication of a user-preferred answer from the second plurality of corresponding predefined answers. In block 710, method 700 includes storing the user selection indication of the selected authentication question and the user selection indication of the user-preferred answer to the selected authentication question. During the authentication phase, in block 712, the method 700 includes displaying the selected authentication question and a third plurality of choices for the user to select. In certain exemplary implementations, the third plurality of choices can include one or more of the user-preferred answers corresponding to the selected authentication question and one or more predefined choices corresponding to the user selection indication of the selected authentication question. In block 714, the method 700 includes receiving a user selection indication from the third plurality of choices. In block 716, the method 700 includes verifying that the user selection indication from the third plurality of choices matches the stored user selection of the user-preferred answer to the selected authentication question. Responsive to the verification, and in block 718, the method 700 includes authenticating the user for access to the service.

In certain exemplary implementations, the list of answers presented to the user for selection may be associated with indices or pointers so that comparison (between the answers selected during enrollment and authentication) only needs to match indices.

In accordance with certain exemplary implementations of the disclosed technology, the third plurality of choices may be characterized by a uniform format.

In certain exemplary implementations, the third plurality of choices has relevancy to the selected authentication question.

In certain exemplary implementations, one or more predefined choices may be randomly selected.

In certain exemplary implementations, during the enrollment phase, all or part of the available questions may be presented to the user to allow the user to choose which ones to answer. In certain exemplary implementations during the authentication stage, logic and/or weighting may be applied for determining which questions (and/or how many questions) to present to the user.

In accordance with certain exemplary implementations of the disclosed technology, the first plurality of predefined authentication questions may be displayed based on a weighting of preferred authentication questions and/or user selection choice of their preferred answer(s) during enrollment. In certain exemplary implementations, the authentication questions may be presented during the authentication stage based on how a user answered more than one question during the enrollment stage by their choice selection(s). Accordingly, certain weighting and/or logic may be applied for determining which questions to display for user selection of a choice in the authentication stage. For example, user preferred answer choices to the authentication questions during enrollment may be tabulated over a population of users to rank answer choices from most prevalent (or most commonly chosen) to most unique (or least commonly chosen) for that population. If a user answered a first authentication question during the enrollment stage by their choice that ranks high in prevalence among their associated population, and if the user answered a second authentication question during the enrollment stage by their choice selection of one of the answer choices that ranks lower in prevalence (i.e., more unique among the associated population), then the authentication question presented during authentication may be automatically selected for presentation (from among the user's previously answered authentication questions) based on the prevalence/uniqueness ranking or weighting so that authentication questions corresponding to most unique answer choice(s) are automatically selected for presentation to the user. In certain exemplary implementations, the above-referenced population could include all users or subgroups of users. In certain exemplary implementations, subgroups of users may be divided by geographical region, etc.

In certain exemplary implementations, the displayed third plurality of choices can include false choices displayed together with the user-preferred answer choice to the selected authentication question. In certain exemplary implementations, the displayed third plurality of choices may include only choices that the user did not select during authentication, and for which the associated question would be considered a “Red-Herring” question since the correct answer would be “none of the above.”

In certain exemplary implementations, the user-preferred answer may be stored and displayed in a format that does not require the user to remember the text formatting of the user-preferred answer. For example, a proper case format may be utilized, in which the first letter of each word may be capitalized, and the remaining letters may be converted to lowercase. Other example implementation may allow the enterprise customer to make all choices for formatting, including all uppercase or all lowercase. Other display choices may be defined according to specific questions. For example, a list of city names could use hyphens, as in “Los-Angeles”, or contain the state abbreviation, like “Los Angeles, CA”, or show the full state name, or show only the city name, etc.

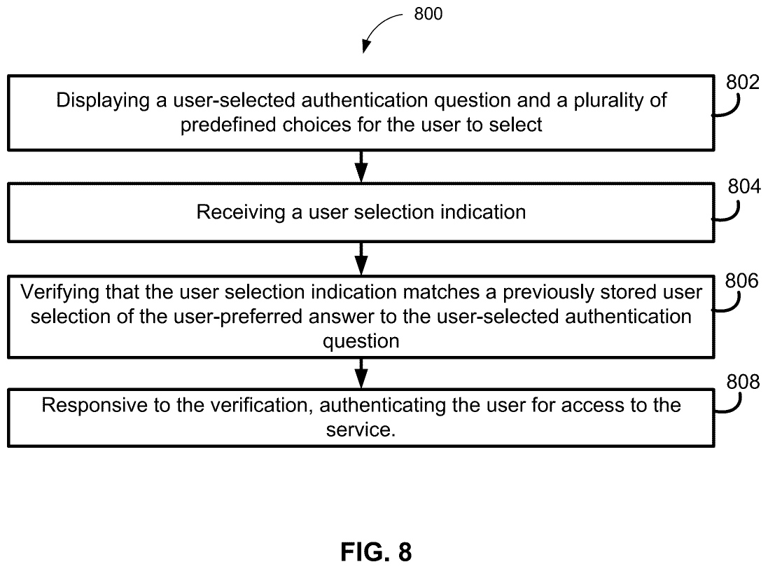

FIG. 8 is a flow diagram of a method 800 for user authentication for access to a service using shared secret questions, according to an example implementation of the disclosed technology. The method 800 begins in block 802 and includes displaying a user-selected authentication question and a plurality of choices for the user to select. In accordance with certain exemplary implementations of the disclosed technology, the plurality of choices can include one or more of a previously selected user-preferred answer corresponding to the user-selected authentication question and one or more predefined choices corresponding to a user-selection indication of the user-selected authentication question. In block 804, the method 800 includes receiving a user selection indication from the plurality of choices. In block 806, the method 800 includes verifying that the user selection indication from the plurality of choices matches a previously stored user selection of the user-preferred answer to the selected authentication question. In block 808, the method 800 includes. In block 810, method 800 includes. In block 812, and responsive to the verification, the method 800 includes authenticating the user for access to the service.

In certain exemplary implementations, the plurality of choices is characterized by a uniform format.

In certain exemplary implementations, the plurality of choices has relevance to the selected authentication question.

In certain exemplary implementations, one or more predefined choices are randomly selected.

In certain exemplary implementations, the user-selected authentication question is displayed based on a weighting. In certain exemplary implementations, the user-selected authentication question is displayed based on a weighting of preferred authentication questions. In certain exemplary implementations, the user-selected authentication question is displayed based on a weighting of user answer choices received during enrollment.

In certain exemplary implementations, the displayed plurality of choices can include one or more answers as false choices. In certain exemplary implementations, the displayed plurality of choices can include one or more false choices that are displayed together with the user-preferred answer to the selected authentication question.

In certain exemplary implementations, the user-preferred answer is stored and displayed in a format that does not require the user to remember the text formatting of the user-preferred answer.

In certain exemplary implementations, one or more predefined choices corresponding to the user selection indication of the selected authentication question are characterized by a uniform format and have relevancy to the selected authentication question.

The disclosed technology can provide improved and efficient authentication security by retrieving and presenting a pre-defined list of security answers for selection by the user. Based on a correct selection of the answer that the user either recognizes or does not recognize, the user may be authenticated.

A legitimate user, as defined herein, is a person who represents their true identity, for example, in the process of identity verification (as opposed to a fraudster who may misrepresent their identity as someone else). In certain exemplary implementations, the legitimacy of a user may be determined based on answers selected, depending on accompanying instructions for selection. Authentication of the user may be provided based on a correct selection response by the user, i.e., correctly identifying the predefined answer (or “none of the above”) according to the presented question and answers.

In an example implementation, the received set of identity information may also include information that may directly or indirectly identify certain characteristics about the communication channel and/or user device 302 used by the user (202 204), such as a phone number, IP address, MAC address, location, signal-to-noise, unique browser configuration, operating system, installed fonts, installed plug-ins, etc. In an example implementation, the characteristics of the communication channel 308 or device 302 may be utilized in conjunction with the selection(s) received to determine one or more of:
if the received phone number associated with the communication channel or device 302 differs or is altered in some way from the originating device phone number (i.e. spoofed);
if the user's communication device 302 is located where it would be expected to be (i.e., within the home city or state of the user);
if the user's communication device 302 is located in a region associated with a high crime rate;
if the user's communication device 302 is located in a foreign country;
details about the user's communication device 302 (i.e., device fingerprinting) that may be corroborated by independent information.

Depending on the analysis of the response, or other factors where risk is determined to be higher than acceptable, the user may be presented with other options or instructions to further validate his or her identity. For example, certain embodiments may include online or offline capture of identification documents (such as a driver's license, social security card, credit card, bank card, utility bill, tax return, etc.,) for further identity verification.

The identity authentication process disclosed herein may utilize all or part of the previously gathered, compared, analyzed, and/or scored information to determine a fraud risk score. In certain example implementations, the fraud risk score may provide additional confidence for accepting or rejecting the authentication.

If the received response from the user is determined to correspond to the correct answer, certain implementations can further include initiating biometric capture of the user. For example, in certain example implementations, biometric capture may be used to associate the user identity information with some type of physically verifiable (biometric) information, such as a fingerprint, a voiceprint, an iris image, a facial image, etc.

If the user does not select the correct answer, certain implementations may prevent or block additional authentication steps and an indication of failure may be output. For example, in situations where the risk is determined to be higher than acceptable, the user may be presented with other options or instructions to validate his or her identity.

In some implementations, the initial and/or additional authentication process steps may be controlled based on company or governmental oversight policy. For example, in order to conform to certain state laws, an authentication challenge method to verify identity may need to be based on commercially reasonable tools. In other situations, and depending on the business policy, certain transactions may require a specific type of authentication. Certain banks, for example, may require authentication for balance transfers over $10,000.

In accordance with certain exemplary implementations of the disclosed technology, multiple question panes populated with answers for selection may be characterized by the same, different, and/or mixed categories for presentation to a user for multiple-choice selection. In some implementations, authentication of the user's identity may require that the user review and correctly answer multiple question panes. In some implementations, if a user provides an incorrect answer, the system may generate and present additional question panes to the user. Provided the user correctly answers a predetermined number or percentage of the question panes within a limited or allotted time, the system may authenticate the user.

One objective of the disclosed technology is to raise the strength and security of the authentication process by forcing a user (who may or may not be legitimate) to provide an indication of a “knowledge” factor via the selection of recognized (and/or not recognized) answers. Certain implementations of the disclosed technology may provide additional security by also requiring a “possession” factor. In certain implementations, the pane(s) with answers for selection may be sent to a user using various so-called “out-of-band” communication channels or combinations of channels such as by messaging, URL access, etc. For example, in one implementation, the question pane may be sent or presented to a user using one communication channel or device (such as via a browser on a desktop computer) while codes for the correct answer selection may be sent or presented to the user using another communication channel or device (such as via a text message on a smartphone). Such multi-channel/device communications may provide a “possession” factor for security in an authentication process.

In certain example implementations, the techniques as disclosed herein may provide enhanced confidence that an individual is who they claim to be based on their ability to recognize previously selected and preformatted answers to authentication questions. Certain example implementations may help minimize the probability of a fraudster acquiring the necessary information to correctly answer the question.

Certain implementations can further impose a time limit on receiving the selection response. In some implementations, the time limit is less than one minute.

In some implementations, and responsive to an incorrect selection response, an indication of authentication failure may be sent to the user's computing device for display.

Certain example implementations of the disclosed technology may enable effective determination and management of identity fraud risk. Certain implementations may be utilized to detect suspicious and/or fraudulent activities associated with the process of establishing a new account. For example, a user seeking to establish a new account (such as a credit account, banking account, utility account, etc.) or apply for a benefit or service (such as a tax refund, etc.) may provide a basic set of identity information such as a name, address, telephone number, social security number, etc. In an example implementation, all or part of the set of identity information may be utilized to query one or more public and/or private databases to obtain independent information. In certain example implementations, the independent information may be processed to determine/detect/score indicators of risk. According to an example implementation of the disclosed technology, account applicants who fail the authentication may not be allowed to proceed.

Certain example embodiments of the disclosed technology may allow for offline, manual, and/or custom validation of a user's identity when the user fails the authentication. For example, certain legitimate users may fail due to various factors. In these situations, it may be possible to obtain the appropriate authentication by offline, manual, and/or custom validation. For example, in one implementation, a user who fails authentication may be asked to provide additional proof of their identity. In another example implementation, a user who fails one of the stages may be asked to appear in person at a vendor location for further questioning and/or documentation.

Certain embodiments utilize non-fair credit reporting act (non-FCRA) implementations, for example, so if a user fails one or more stages, such information will not be utilized for denying employment, credit, etc. In such situations, a vendor for which the user is seeking authentication may provide other offline, manual, and/or custom validation options. However, if the user passes the authentication, then the process may be utilized to initiate the authentication, such as biometric authentication. Furthermore, if the user passes the authentication process, certain implementations of the disclosed technology may provide an efficient means for identity authentication.

According to example implementations, certain technical effects can be provided, such as creating certain systems and methods that may reduce fraud losses and improve operational efficiency. Example implementations of the disclosed technology can provide further technical effects by providing systems and methods for detecting identity fraud. Certain implementations of the disclosed technology may further provide the technical effects of authenticating a user's identity via a shared secret process.

In certain example implementations of the disclosed technology, the identity authentication process may be implemented using any number of hardware and/or software applications that are executed to facilitate any of the operations. In example implementations, one or more I/O interfaces may facilitate communication between the identity authentication system and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the identity authentication system. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate the connection of the identity authentication system inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, implementations of the disclosed technology may include an identity authentication system with more or less of the components illustrated in FIG. 2, 3, or 6.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements, or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description herein uses examples to disclose certain implementations that enable any person skilled in the art to practice the disclosed technology, including making and using any devices or systems and performing any incorporated methods. The patentable scope of the disclosed technology is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method for user enrollment and authentication for access to a service using shared secret questions, comprising:
during an enrollment phase:
displaying, via a user interface, a first plurality of predefined authentication questions, each of the predefined authentication questions having a second plurality of corresponding predefined answers;
receiving, in response to the displaying, a user selection indication of a selected authentication question from the first plurality of predefined authentication questions;
displaying, in response to the user selection indication of the selected authentication question, at least a subset of the second plurality of corresponding predefined answers;
receiving a user selection indication of a user-preferred answer from the second plurality of corresponding predefined answers; and
storing the user selection indication of the selected authentication question and the user selection indication of the user-preferred answer to the selected authentication question;
during an authentication phase:
displaying the selected authentication question and a third plurality of choices for the user to select, the third plurality of choices comprising one or more of:
the user-preferred answer corresponding to the selected authentication question; and
one or more predefined choices corresponding to the user selection indication of the selected authentication question;
receiving a user selection indication from the third plurality of choices;
verifying that the user selection indication from the third plurality of choices matches the stored user selection of the user-preferred answer to the selected authentication question; and
responsive to the verification, authenticating the user for access to the service.

2. The method of claim 1, wherein the third plurality of choices is characterized by a uniform format.

3. The method of claim 1, wherein the third plurality of choices has relevancy to the selected authentication question.

4. The method of claim 1, wherein the one or more predefined choices are randomly selected.

5. The method of claim 1, wherein the first plurality of predefined authentication questions is displayed based on a weighting of the user-preferred answer selected during enrollment relative to answers selected by a population of users.

6. The method of claim 1, wherein the third plurality of choices comprises one or more false choices.

7. The method of claim 1, wherein the user-preferred answer is stored and displayed in a format that does not require the user to remember text formatting of the user-preferred answer.

8. A computer-implemented method for user authentication for access to a service using shared secret questions, comprising:
displaying a user-selected authentication question and a plurality of choices for the user to select, the plurality of choices comprising one or more of:
a previously selected user-preferred answer corresponding to the user-selected authentication question; and
one or more predefined choices corresponding to a user-selection indication of the user-selected authentication question;
receiving a user selection indication;
verifying that the user selection indication matches a previously stored user selection of the user-preferred answer to the selected authentication question; and
responsive to the verification, authenticating the user for access to the service.

9. The method of claim 8, wherein the plurality of choices is characterized by a uniform format.

10. The method of claim 8, wherein the plurality of choices has relevancy to the selected authentication question.

11. The method of claim 8, wherein the one or more predefined choices are randomly selected.

12. The method of claim 8, wherein the user-selected authentication question is displayed based on a weighting.

13. The method of claim 8, wherein the plurality of choices comprises one or more answers as false choices.

14. The method of claim 8, wherein the user-preferred answer is stored and displayed in a format that does not require the user to remember text formatting of the user-preferred answer.

15. The method of claim 8, wherein the one or more predefined choices corresponding to the user selection indication of the selected authentication question are characterized by a uniform format and have relevance to the selected authentication question.

16. A system for user authentication using shared secret questions, the system comprising:
a data repository configured for storing predefined authentication questions, predefined choices, user-selected predefined authentication questions, and user-selected answer choices;
a user interface configured for displaying the predefined authentication questions and receiving user selection indication of a preferred answer from a list of the predefined choices;
a comparison module for verifying that a user-selected preferred answer matches a previously selected preferred answer from the predefined choices;
at least one memory for storing data and computer-executable instructions; and at least one processor configured to access the at least one memory and further configured to execute the computer-executable instructions that cause the at least one processor to:
display, via the user interface, a user previously selected authentication question and a plurality of corresponding choices for the user to select, the plurality of corresponding choices comprising one or more of:
a previously selected user-preferred answer corresponding to the user's previously selected authentication question; and
one or more predefined choices corresponding to the user's previously selected authentication question;
receive, via the user interface, a user selection indication of a selected answer from the plurality of choices;
compare, via the comparison module, the user selection indication with a previously selected preferred answer from the predefined choices;
verify that the user selection indication matches the previously selected preferred answer from the predefined choices; and
responsive to the verification, authenticate the user for access to a service.

17. The system of claim 16, wherein the plurality of choices are displayed using a uniform format and have relevancy to the selected authentication question.

18. The system of claim 16, wherein the user-selected authentication question is displayed based on a weighting.

19. The system of claim 16, wherein the plurality of corresponding choices comprises one or false choices.

20. The system of claim 16, wherein the user-preferred answer is stored and displayed in a format that does not require the user to remember text formatting of the user-preferred answer.
